(19) United States
(12) Patent Application Publication
(10) Pub. No.: US 2016/0188890 A1
(43) Pub. Date: Jun. 30, 2016

(54) SECURITY MODE DATA PROTECTION

(71) Applicant: INTEL CORPORATION, Santa Clara, CA (US)

(72) Inventors: Helia NAEIMI, Santa Clara, CA (US); Shigeki TOMISHIMA, Portland, OR (US); Shih-Lien L. LU, Portland, OR (US)

(21) Appl. No.: 14/583,513

(22) Filed: Dec. 26, 2014

(51) Int. Cl. G06F 21/62; G06F 12/14; G06F 21/79; G06F 12/02

(52) U.S. Cl. CPC G06F 21/62; G06F 12/0246; G06F 12/1433; G06F 21/79; G06F 2212/7201; G06F 2212/7205; G06F 2212/1052

(57) ABSTRACT

In one embodiment, a device containing sensitive information may be placed in a data security mode. In such a data security mode, certain activities may trigger the partial or full erasure of the sensitive date before the data can be retrieved by an unauthorized user. In one embodiment, the data security mode may be a “park” mode in which unauthorized physical movement of the device triggers the partial or full erasure of the sensitive data stored in a nonvolatile memory before the data can be retrieved by an unauthorized user. In another aspect of the present description, the earth's magnetic field may be used to detect movement of a device in the park mode, and may be used to power the erasure of sensitive data as the device is moved relative to the earth's magnetic field. Other aspects are described herein.

### TECHNICAL FIELD

Certain embodiments of the present invention relate generally to nonvolatile memory.

### BACKGROUND

In a nonvolatile memory, the data stored in the memory is retained. Accordingly, nonvolatile memory retains data during stand by and even power down conditions. Thus, nonvolatile memory may be used to store and retain data in a variety of devices including portable devices which may lack an internal power source. However, such data retention may not be appropriate for storing sensitive data such as passwords and personal keys, for example, particularly in portable devices which may be stolen or otherwise more readily accessed by unauthorized users.

One approach for protecting sensitive data has been to program the operating system of the device to store sensitive data in volatile memory. Accordingly, once the device enters the power down condition, removal of power from the volatile memory typically destroys the data in the volatile memory including any sensitive data stored in the volatile memory.

Another approach has been to provide for long range wireless remote control of devices such as cellular telephones, for example, which may be lost or otherwise no longer in the possession of the owner. Such remote control features may permit the rightful owner of the cellular telephone to remotely disable the device or erase sensitive data stored in the memory of the telephone.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating selected aspects of a system employing data security in accordance with an embodiment of the present disclosure.

FIG. 2 depicts a basic architecture of a memory employing data security in accordance with an embodiment of the present disclosure.

FIG. 3 depicts a device having a memory employing data security in accordance with an embodiment of the present disclosure.

FIG. 4 depicts one example of operations for data security in a memory in accordance with an embodiment of the present disclosure.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with the present description, techniques including a sensitive information security circuit are provided for enhancing security of sensitive information stored in memory. In one embodiment, at least a portion of a nonvolatile memory of a device may be automatically erased in response to a detected event such as unauthorized movement of the device, for example. It is recognized herein that it may be appropriate to automatically erase sensitive data stored in nonvolatile memory of a device in response to certain events to prevent or inhibit unauthorized access to the sensitive data which may have been stored in the device. It is further recognized that such sensitive data erasure may be triggered by events in addition to or instead of unauthorized movement, depending upon the particular application.

As used herein, the term “erase” refers to resetting or otherwise changing bits stored in memory to eliminate or increase the difficulty of unauthorized recovery of sensitive data stored in the memory. Thus, bits of sensitive data may be erased by resetting bits from their current state to a logical zero or in some embodiments, by resetting bits from their current state to a logical one. In other embodiments, bits of sensitive data may be erased by randomly flipping states of bits of the sensitive data from their current state to the opposite state. It is appreciated that sensitive data stored in memory may be erased using other bit state changing techniques.

It is further appreciated that preserving the security of sensitive information stored in various devices is of growing concern as the number of devices containing sensitive information proliferates. Sensitive information may include passwords, account numbers, or other information of a business, financial or personal nature. In addition, devices containing such information are becoming increasingly small and portable and therefore more vulnerable to being stolen. Sensitive information stored in a memory of a device in the possession of an unauthorized person may be extracted and used or otherwise disseminated by the unauthorized person.

Moreover, small form factor devices such as credit cards, identity cards and key cards, for example, may be particularly vulnerable to data breaches. A larger form factor device such as a cellular telephone typically has a battery or other active power source to power security protection. For example, a cellular telephone may have the capability of permitting the owner of the cellular telephone to remotely instruct the cellular telephone to destroy sensitive data in the event the telephone becomes lost or stolen before the information is compromised. By comparison, small form factor devices frequently lack costly long range wireless connections and active power sources for such security features.

In one aspect of the present description, a device containing sensitive information may be placed in a data security mode. In such a data security mode, certain activities may trigger the partial or full erasure of the sensitive data before the data can be retrieved by an unauthorized user.

In one embodiment, the data security mode may be a “park” mode in which unauthorized physical movement of the device triggers the partial or full erasure of the sensitive data stored in a nonvolatile memory before the data can be retrieved by an unauthorized user. It is appreciated herein that unauthorized access to sensitive data in a device often begins with the device being taken by an unauthorized user and moving the device to another location to open the device to retrieve the sensitive data. In accordance with the present description, once such unauthorized movement begins while the device is in the park mode, erasure of sensitive data by the sensitive information security circuit begins and continues in response to continued movement in the park mode. Conversely, upon disabling the park mode of the device, the device may be freely moved by the user without causing the erasure of data.

In another aspect of the present description, the earth's magnetic field may be used to detect movement of a device in the park mode, and may be used to power the erasure of sensitive data as the device is moved relative to the earth's magnetic field. As a result, techniques for enhancing security of sensitive information stored in memory as described herein may be utilized by a variety of devices including small form factor devices which may lack an internal power source, for example. It is appreciated that other types of motion detectors may be utilized, depending upon the particular application.

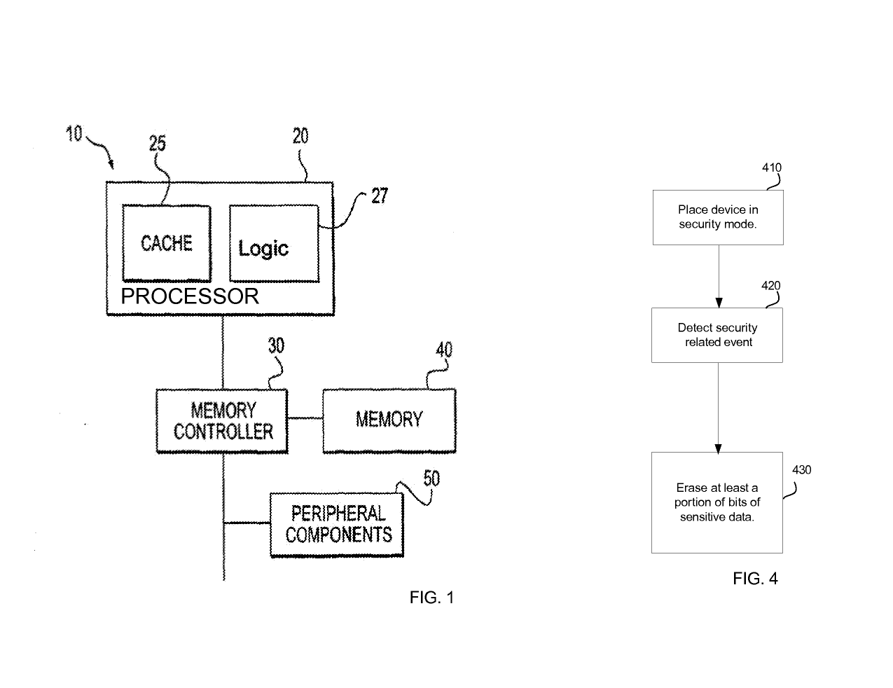

Turning to the figures, FIG. 1 is a high-level block diagram illustrating selected aspects of a system implemented, according to an embodiment of the present disclosure. System 10 may represent any of a number of electronic and/or computing devices, that may include a memory device. Such electronic and/or computing devices may include large form computing devices and small form computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.), credit cards, identity cards, key cards or component (e.g. system on a chip, processor, bridge, memory controller, memory, etc.). In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs).

In the illustrative example, system 10 comprises a processor 20 such as a microprocessor or other logic device, a memory controller 30, a memory 40 and peripheral components 50 which may include a sensitive information security circuit in accordance with the present description. The peripheral components 50 may also include, for example, a video controller, input device, output device, storage, network adapter, etc. The processor 20 may optionally include a cache 25 that may be part of a memory hierarchy to store instructions and data, and the system memory 40 may also be part of the memory hierarchy. Communication between the processor 20 and the memory 40 may be facilitated by the memory controller (or chipset) 30, which may also facilitate in communicating with the peripheral components 50.

Storage of the peripheral components 50 may be, for example, nonvolatile storage, such as solid-state drives, magnetic disk drives, optical disk drives, a tape drive, flash memory, etc. The storage may comprise an internal storage device or an attached or network accessible storage. The processor 20 is configured to write data in and read data from the memory 40. Programs in the storage are loaded into the memory and executed by the processor. A network controller or adapter enables communication with a network, such as an Ethernet, a Fiber Channel Arbitrated Loop, etc. Further, the architecture may, in certain embodiments, include a video controller configured to render information on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. The network adapter may embodied on a network card, such as a Peripheral Component Interconnect (PCI) card, PCI-express, or some other I/O card, or on integrated circuit components mounted on a motherboard or other substrate.

One or more of the components of the device 10 may be omitted, depending upon the particular application. For example, a network router may lack a video controller, or wireless input/output devices, for example. In another example, small form factor devices such as credit cards, for example, may lack many of the components discussed above and may be limited primarily to logic and memory as well as a sensitive information security circuit as described herein.

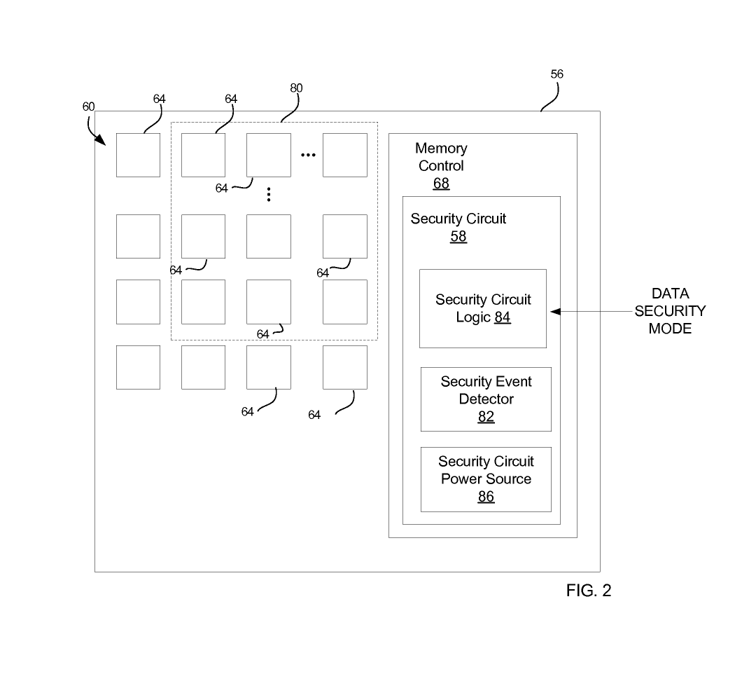

Any one or more of the memory devices 25, 40, and the other devices 10, 20, 30, 50 may include a sensitive information security circuit in accordance with the present description. FIG. 2 shows an example of a memory 56 having a sensitive information security circuit 58 in accordance with one embodiment of the present description. The memory 56 includes an array 60 of rows and columns of bitcells 64 of a nonvolatile memory such as, for example, a Spin Transfer Torque Random Access Memory (STTRAM) which is a type of magnetoresistive Random Access Memory (MRAM). It is appreciated that the memory 56 may be other types of MRAM memory or other types of nonvolatile memory such as single or multi-threshold level NAND flash memory, NOR flash memory, single or multilevel phase change memory (PCM, PRAM), byte addressable three-dimensional (3D) cross-point memory, resistive memory, nanowire memory, ferroelectric transistor memory (F-RAM, FeTRAM), thermal-assisted switching memory (TAS), millipede memory, floating junction gate memory (FJG RAM), battery-backed RAM, memristor-based memory, or a combination of any of the above, or may be a volatile memory such as a DRAM memory, for example.

The memory 56 may also include a row decoder, a timer device and I/O devices. Bits of the same memory word may be separated from each other for efficient I/O design. A multiplexer (MUX) may be used to connect each column to the required circuitry during a READ operation. Another MUX may be used to connect each column to a write driver during a WRITE operation. A control circuit 68 performs read operations, write operations and utilizes the security circuit 58 to perform sensitive information security operations to the bitcells 64 as explained below. The control circuit 68 is configured to perform the described operations using appropriate hardware, software or firmware, or various combinations thereof.

In one embodiment, a portion 80 of the memory 56 is a subarray of bitcells 64 containing sensitive information. In this example, the operating system of the device has designated the subarray 80 for storing sensitive information. The size and location of the subarray 80 may vary, depending upon the particular application. At least a portion of the bits stored in the subarray 80 may be automatically erased in response to a detected event such as unauthorized movement of the device, for example.

In this embodiment, the sensitive information security circuit 58 includes a security event detector 82 which detects a security event such as unauthorized movement of the device, for example. In response to detection of the security event, a security circuit logic circuit 84 of the sensitive information security circuit 58 commences erasing at least a portion of the bits stored in the subarray 80 containing the sensitive information, if the device has been placed in a data security mode as represented by a data security mode signal. An example of one such data security mode is a “park” mode in which detection of motion by the detector 82 results in erasure of at least some sensitive information stored in the subarray 80.

Accordingly, one example of a suitable security event detector is a motion detector which detects motion of the memory 56 which may be unauthorized motion as indicated by the state of the data security mode signal. It is appreciated that a security event detector 82 in accordance with the present description may detect other types of security events. For example, in a large form factor device having an internal power source, the device entering a power on or power off mode may represent a security event. In such applications, the security event detector 82 may detect the device entering a power on or power off mode. In response, the security circuit logic circuit 84 of the sensitive information security circuit 58 commences erasing at least a portion of the bits stored in the subarray 80 containing the sensitive information, if the device has been placed in a data security mode as represented by a data security mode signal.

In some embodiments, such as a small form factor device such as a credit card or key card, for example, the device may lack an internal power source such as a battery to power logic circuitry of the device. Accordingly, in these embodiments, the sensitive information security circuit 58 may optionally include a security circuit power source 86 which powers the security operations of the sensitive information security circuit 58. In one embodiment, the security circuit power source 86 may be an active source of power such as a battery or external line power. In other embodiments, the security circuit power source 86 may be a passive power source. One example of a passive power source of the security circuit power source 86 may include a coil which generates power by electromagnetic induction in response to relative motion of the device with respect to the earth's magnetic fields. Another example, is an internal antennae which may provide power in response to an externally provided RF signal received by the internal antenna. For example, an RFID circuit may be excited with a wireless RF signal provided externally from the device. Yet another example is a photo-voltaic array which generates electricity in response to solar or other radiation. It is appreciated that other active and passive power sources may be provided for the security circuit 58, depending upon the particular application.

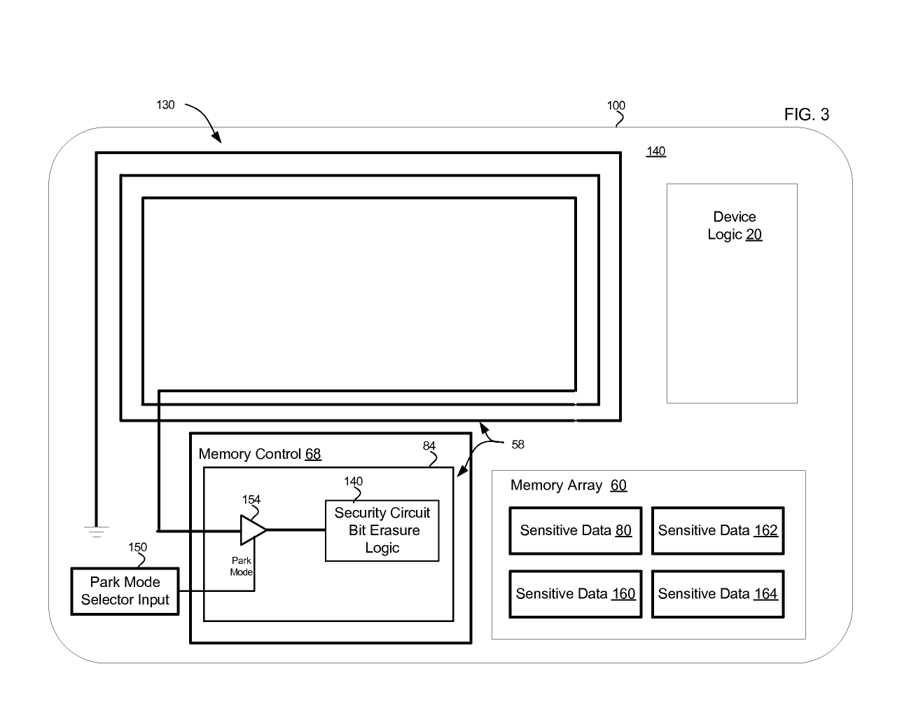

Although the security circuit logic 84, security event detector 82 and the security circuit power source 86 of the security circuit 58 are depicted separately in the schematic diagram of FIG. 2, it is appreciated that one or more of these functions may be combined so as to be provided by a single device. For example, FIG. 3 shows a small form factor device 100 having a sensitive information security circuit 58 in accordance with one embodiment of the present description. In this example, the sensitive information security circuit 58 includes security circuit logic 84 similar to the security circuit logic 84 discussed above in connection with FIG. 2. Here, the functions of the security event detector 82 and the security circuit power source 86 of FIG. 2 are provided by a combined device which includes a multi-turn coil 130 embedded in a plastic substrate 140 of the device 100 which may be a credit card or key card, for example. It is appreciated that the substrate 140 may be made of any suitable material, depending upon the particular application.

In accordance with one aspect of the present description, the earth's magnetic field is utilized to provide for data security. In the embodiment of FIG. 3, the coil 130 is placed around the device 100 to detect motion and to generate electric current. As the device 100 is moved, the earth's magnetic field inside the coil 130 changes, causing current to flow through the coil 130. In accordance with the present description, this earth's magnetic field generated current may be used to both signal a security event and to provide the power to erase data in a memory such as the nonvolatile memory subarray 60. Sensitive data may be erased in its entirety by a security circuit bit erasure logic 140, or selected bits may be erased to change the information partially. In this embodiment, the coil 130 functions as a motion detector to detect unauthorized motion of the device 100 as a security event. It is appreciated that other types of motion detectors may be utilized, depending upon the particular application. For example, gyro sensors may be utilized as motion detectors.

The amount of current generated by the coil 130 is a function of the size of the coil, the number of turns of the coil and the change in the earth's magnetic field passing through the coil 130 as a result of motion of the device 100. In one example, for a credit card size form factor of the device 100, the coil 130 may be formed of a wire having a thickness of approximately 1 mm, for example, and may have, in this example, approximately three turns. The current generated by such a coil 130 in the device 100 may be calculated to be approximately 1 mA in one full turn of the coil 130 as the device 100 is moved by a person carrying the device 100.

In accordance with the present description, such a quantity of current generated using the earth's magnetic field is sufficient not only to provide a signal indicating movement of the device 100, but also to erase some or all of the bits of sensitive data. In this example, the current generated by motion of the coil 130 through the earth's magnetic field is enough to erase on average 10-20 bits every 10 ns as the motion of the device continues. It is appreciated that the amount of current generated, and the number of bits which may be erased utilizing that generated current, will vary, depending upon the particular application.

In another aspect of the present description, the device 100 has an input 150 by which the user may selectively place the device 100 in the park mode in which the output of the coil 130 is coupled by a switch 154 to the security circuit bit erasure logic 140. The device may detect whether it is in a security mode such as the park mode by the state of the switch 154. Thus, in the park mode, current generated by the coil 130 in response to motion of the device 100, is directed by the switch 154 to the security circuit bit erasure logic 140 to signal the unauthorized motion of the device 100 in the park mode and to provide the power to erase bits of the array 80. The input 150 may be any suitable input device such as a touch sensitive area of the device 100, for example.

The input 150 may also be used to selectively disable the park mode or otherwise release the device 100 from the park mode. When in the second “nonpark” security mode, the coil 130 is disabled by the switch 154 and removed from the security circuit 58. As a result, the security circuit bit erasure logic 140 is disabled and the device 100 may be freely moved without initiating the erasure of data. Security codes or patterns known to the authorized user may be programmed into the device 100 to ensure that the device 100 is not inadvertently switched to the park mode by the authorized user and is not released from the park mode by an unauthorized user.

In one embodiment in which the sensitive data is stored in a subarray of the memory, the portion of bits which are erased to destroy or at least obfuscate sensitive information may be randomly distributed over the subarray. Such a random distribution of erased bits of sensitive data is believed to enhance prevention of unauthorized recovery of the sensitive data. It is recognized that random distribution of erased bits of sensitive data may be achieved in a variety of techniques, depending upon the particular application.

For example, it is recognized that physical characteristics of individual bitcells of an array of bitcells in a memory may vary from bitcell to bitcell as a result of variations encountered in typical fabrication processes. One such physical characteristic which may randomly vary from bitcell to bitcell is the level of write current at which a particular bitcell may be changed from one state to another. Thus, a percentage of the bitcells of a subarray may be changed with a relatively weak write current. Such bitcells referred to herein as “weak bitcells” may also be changed relatively quickly as compared to other bitcells of the array. As a consequence, “weak bit” bitcells which may be changed relatively quickly with a relatively weak write current may be randomly distributed over a subarray. By applying the relatively weak write current to the subarray over a relatively short period of time, the weak bit bitcells may be changed. Conversely, those “strong bit” bitcells which may be changed upon application of a relatively strong write current over a relatively long period of time may remain unchanged in the presence of the weak write current. However, the changing of the randomly distributed weak bit bitcells may be sufficient to render unauthorized recovery of the sensitive data of the subarray as a whole sufficiently impractical notwithstanding that the bits of the strong bitcells may remain unchanged. In this manner, write current and write time for sensitive data erasure may be correspondingly reduced to a level lower than that utilized to ensure erasure of all bitcells including strong bit bitcells.

In another aspect of the present description, random distribution of erased bits to protect against unauthorized recovery of sensitive data may be achieved by an on-board randomization circuit of the security circuit bit erasure logic 140. In response to detection of a security event such unauthorized motion of the device 100 in the park mode, the randomization circuit may randomly select bits of the sensitive data to be erased. It is appreciated that in some embodiments, erasure of bits of sensitive data may occur automatically in response to detection of a security related event. In other embodiments, sensitive data erasure may be triggered manually by the authorized user.

It is further appreciated that a device such as the device 100 may contain different tiers of sensitive data such that sensitive data stored in the subarrays 80, 160, 162, and 164, for example, may have varying degrees of sensitivity. Thus, the sensitive data stored in the subarray 80 may be most sensitive, the sensitive data stored in the subarray 164 may be the least sensitive, and the sensitive data stored in the subarrays 160 and 162 may be more sensitive than the sensitive data of the subarray 164 but less sensitive than the sensitive data of the subarray 80.

In yet another aspect of the present description, upon detection of a security event such as unauthorized motion of the device 100 while placed in the park mode, the security circuit bit erasure logic 140 may initiate erasure of bits of the most sensitive data such as that stored in in the subarray 80 first. Upon completion of erasure of a sufficient number of bits of the subarray 80, the security circuit bit erasure logic 140 may initiate erasure of bits of the next most sensitive data of the different tiers of sensitive data such as that stored in in the subarray 160, for example. Upon completion of erasure of a sufficient number of bits of the subarrays 80, 160, 162, the security circuit bit erasure logic 140 may initiate erasure of bits of the least sensitive data of the subarray 164, for example.

FIG. 4 shows one example of operations of a device such as a microprocessor controlled device 10 of FIG. 1 in which the device is placed (block 410) in a security mode such as a park security mode, for example. In this security mode, a security related event is detected (block 420). As previously mentioned, one example of such a security related event may be unauthorized motion of the device when placed in a park mode. The coil 130 is an example of a motion detector utilizing the earth's magnetic field.

Upon detection of a security related event, at least a portion of the bits representing sensitive data stored in a subarray may be erased (block 430). As previously mentioned, the coil 130 is an example of a power source utilizing the earth's magnetic field to generate current to erase bits of sensitive data as the device is moved. Upon erasure of some or all of the sensitive information stored in the subarray, it is believed that unauthorized recovery of the sensitive information is prevented or rendered more difficult as to be impractical in many applications.

### EXAMPLES

The following examples pertain to further embodiments.

Example 1 is an apparatus, comprising:

a memory configured to store sensitive information in at least a portion of the memory;

a detector configured to detect a security event;

a selector input configured to input a security mode selection; and

a controller coupled to the detector, memory and selector input, said controller configured to receive a security mode selection, and to protect sensitive information stored as data in the at least a portion of the memory, including said controller configured to:

place the apparatus carrying the memory in a security mode in response to a received security mode selection; and

in response to said detector detecting a first security event while the controller is in the security mode, change bits of said data of said sensitive information to prevent recovery of at least a portion of said sensitive information by reading said portion of said memory.

In Example 2, the subject matter of Examples 1-7 (excluding the present Example) can optionally include that said memory is a nonvolatile memory and said detector is a motion detector configured to detect motion of the apparatus wherein said detecting a first security event includes detecting motion of the apparatus carrying said nonvolatile memory.

In Example 3, the subject matter of Examples 1-7 (excluding the present Example) can optionally include that the motion detector includes a coil configured to detect motion by generating a current in the coil by electromagnetic induction caused by motion of the coil through the earth's magnetic field wherein said detecting a first security event includes generating a current in the coil by electromagnetic induction caused by motion of the coil through the earth's magnetic field.

In Example 4, the subject matter of Examples 1-7 (excluding the present Example) can optionally include that said controller includes a switch configured to direct said generated current to said controller, and wherein said controller is configured to use said generated current to change bits of said data of said sensitive information to prevent recovery of at least a portion of said sensitive information.

In Example 5, the subject matter of Examples 1-7 (excluding the present Example) can optionally include that said first security mode is a park security mode wherein said controller is configured to:

place the apparatus carrying the memory in the park security mode in response to a received park security mode selection; and

in response to said motion detector detecting motion of the apparatus carrying said nonvolatile memory while the controller is in the park security mode, change bits of said data of said sensitive information when said apparatus is detected to be in motion while in said park security mode.

In Example 6, the subject matter of Examples 1-7 (excluding the present Example) can optionally include that said controller is configured to enable said switch when said apparatus is placed in the park security mode, so that said generated current is directed to said controller so that so that bits of said data of said sensitive information are changed by said generated current when said apparatus is in motion while in said park mode.

In Example 7, the subject matter of Examples 1-7 (excluding the present Example) can optionally include that the selector input is configured to input a second mode selection other than said park mode, wherein said controller is configured to disable said switch when said apparatus is placed in the second mode which disables said directing said generated current to said controller so that any current generated by motion of the coil through the earth's magnetic field when the apparatus is in the second mode is disabled from changing bits of said data of said sensitive information when said apparatus is in motion while in said second mode.

Example 8 is a computing system for use with a display, comprising:

a memory configured to store sensitive information in at least a portion of the memory;

a processor configured to write data in and read data from the memory;

a video controller configured to display information represented by data in the memory;

a detector configured to detect a security event;

a selector input configured to input a security mode selection; and

a controller coupled to the detector, memory and selector input, said controller configured to receive a security mode selection, and to protect sensitive information stored as data in the at least a portion of the memory, including said controller configured to:

place the apparatus carrying the memory in a security mode in response to a received security mode selection; and

in response to said detector detecting a first security event while the controller is in the security mode, change bits of said data of said sensitive information to prevent recovery of at least a portion of said sensitive information by reading said portion of said memory.

In Example 9, the subject matter of Examples 8-14 (excluding the present Example) can optionally include that said memory is a nonvolatile memory and said detector is a motion detector configured to detect motion of the apparatus wherein said detecting a first security event includes detecting motion of the apparatus carrying said nonvolatile memory.

In Example 10, the subject matter of Examples 8-14 (excluding the present Example) can optionally include that the motion detector includes a coil configured to detect motion by generating a current in the coil by electromagnetic induction caused by motion of the coil through the earth's magnetic field wherein said detecting a first security event includes generating a current in the coil by electromagnetic induction caused by motion of the coil through the earth's magnetic field.

In Example 11, the subject matter of Examples 8-14 (excluding the present Example) can optionally include that said controller includes a switch configured to direct said generated current to said controller, and wherein said controller is configured to use said generated current to change bits of said data of said sensitive information to prevent recovery of at least a portion of said sensitive information.

In Example 12, the subject matter of Examples 8-14 (excluding the present Example) can optionally include that said first security mode is a park security mode wherein said controller is configured to:

place the apparatus carrying the memory in the park security mode in response to a received park security mode selection; and

in response to said motion detector detecting motion of the apparatus carrying said nonvolatile memory while the controller is in the park security mode, change bits of said data of said sensitive information when said apparatus is detected to be in motion while in said park security mode.

In Example 13, the subject matter of Examples 8-14 (excluding the present Example) can optionally include that said controller is configured to enable said switch when said apparatus is placed in the park security mode, so that said generated current is directed to said controller so that so that bits of said data of said sensitive information are changed by said generated current when said apparatus is in motion while in said park mode.

In Example 14, the subject matter of Examples 8-14 (excluding the present Example) can optionally include that selector input is configured to input a second mode selection other than said park mode, wherein said controller is configured to disable said switch when said apparatus is placed in the second mode which disables said directing said generated current to said controller so that any current generated by motion of the coil through the earth's magnetic field when the apparatus is in the second mode is disabled from changing bits of said data of said sensitive information when said apparatus is in motion while in said second mode.

Example 15 is a method, comprising:

protecting sensitive information stored as data in at least a portion of a memory, said protecting including:

selectively placing an apparatus carrying the memory in a security mode;

detecting a first event while in the security mode; and

in response to said first event detecting, changing bits of said data of said sensitive information to prevent recovery of at least a portion of said sensitive information by reading said portion of said memory.

In Example 16, the subject matter of Examples 15-21 (excluding the present Example) can optionally include that said memory is a nonvolatile memory and wherein said detecting a first event includes detecting motion of the apparatus carrying said nonvolatile memory.

In Example 17, the subject matter of Examples 15-21 (excluding the present Example) can optionally include that the motion detecting includes generating a current in a coil by electromagnetic induction caused by motion of the coil through the earth's magnetic field.

In Example 18, the subject matter of Examples 15-21 (excluding the present Example) can optionally include that said changing bits of said data including directing said generated current to a controller, said controller using said generated current to change bits of said data of said sensitive information to prevent recovery of at least a portion of said sensitive information.

In Example 19, the subject matter of Examples 15-21 (excluding the present Example) can optionally include that the placing an apparatus carrying the memory in a security mode includes selectively placing the apparatus in a park security mode, wherein said detecting the first event includes detecting whether the apparatus is in the park security mode, and detecting motion of the apparatus carrying said nonvolatile memory when the apparatus is in the park security mode so that bits of said data of said sensitive information are changed when said apparatus is detected to be in motion while in said park mode.

In Example 20, the subject matter of Examples 15-21 (excluding the present Example) can optionally include selectively placing the apparatus in a park security mode which enables said directing said generated current to said controller so that motion of the coil through the earth's magnetic field when the apparatus is in the park mode, generates current which is directed to said controller so that bits of said data of said sensitive information are changed by said controller using current generated when said apparatus is in motion while in said park mode.

In Example 21, the subject matter of Examples 15-21 (excluding the present Example) can optionally include selectively placing the apparatus in a second mode other than said park mode, which disables said directing said generated current to said controller so that any current generated by motion of the coil through the earth's magnetic field when the apparatus is in the second mode is disabled from changing bits of said data of said sensitive information when said apparatus is in motion while in said second mode.

Example 22 is directed to an apparatus comprising means to perform a method as described in any preceding Example.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and nonvolatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus, comprising:
a memory configured to store sensitive information in at least a portion of the memory;
a detector configured to detect a security event;
a selector input configured to input a security mode selection; and
a controller coupled to the detector, memory and selector input, said controller configured to receive a security mode selection, and to protect sensitive information stored as data in the at least a portion of the memory, including said controller configured to:
place the apparatus carrying the memory in a security mode in response to a received security mode selection; and
in response to said detector detecting a first security event while the controller is in the security mode, change bits of said data of said sensitive information to prevent recovery of at least a portion of said sensitive information by reading said portion of said memory.

2. The apparatus of claim 1 wherein said detector is a motion detector configured to detect motion of the apparatus wherein said detecting a first security event includes detecting motion of the apparatus carrying said nonvolatile memory.

3. The apparatus of claim 2 wherein the motion detector includes a coil configured to detect motion by generating a current in the coil by electromagnetic induction caused by motion of the coil through the earth's magnetic field wherein said detecting a first security event includes generating a current in the coil by electromagnetic induction caused by motion of the coil through the earth's magnetic field.

4. The apparatus of claim 3 wherein said controller includes a switch configured to direct said generated current to said controller, and wherein said controller is configured to use said generated current to change bits of said data of said sensitive information to prevent recovery of at least a portion of said sensitive information.

5. The apparatus of claim 4 wherein said first security mode is a park security mode wherein said controller is configured to:
place the apparatus carrying the memory in the park security mode in response to a received park security mode selection; and
in response to said motion detector detecting motion of the apparatus carrying said nonvolatile memory while the controller is in the park security mode, change bits of said data of said sensitive information when said apparatus is detected to be in motion while in said park security mode.

6. The apparatus of claim 5 wherein said controller is configured to enable said switch when said apparatus is placed in the park security mode, so that said generated current is directed to said controller so that so that bits of said data of said sensitive information are changed by said generated current when said apparatus is in motion while in said park mode.

7. The apparatus of claim 6 wherein the selector input is configured to input a second mode selection other than said park mode, wherein said controller is configured to disable said switch when said apparatus is placed in the second mode which disables said directing said generated current to said controller so that any current generated by motion of the coil through the earth's magnetic field when the apparatus is in the second mode is disabled from changing bits of said data of said sensitive information when said apparatus is in motion while in said second mode.

8. A computing system for use with a display, comprising:
a memory configured to store sensitive information in at least a portion of the memory;
a processor configured to write data in and read data from the memory;
a video controller configured to display information represented by data in the memory;
a detector configured to detect a security event;
a selector input configured to input a security mode selection; and
a controller coupled to the detector, memory and selector input, said controller configured to receive a security mode selection, and to protect sensitive information stored as data in the at least a portion of the memory, including said controller configured to:
place the apparatus carrying the memory in a security mode in response to a received security mode selection; and
in response to said detector detecting a first security event while the controller is in the security mode, change bits of said data of said sensitive information to prevent recovery of at least a portion of said sensitive information by reading said portion of said memory.

9. The system of claim 8 wherein said memory is a nonvolatile memory and said detector is a motion detector configured to detect motion of the apparatus wherein said detecting a first security event includes detecting motion of the apparatus carrying said nonvolatile memory.

10. The system of claim 9 wherein the motion detector includes a coil configured to detect motion by generating a current in the coil by electromagnetic induction caused by motion of the coil through the earth's magnetic field wherein said detecting a first security event includes generating a current in the coil by electromagnetic induction caused by motion of the coil through the earth's magnetic field.

11. The system of claim 10 wherein said controller includes a switch configured to direct said generated current to said controller, and wherein said controller is configured to use said generated current to change bits of said data of said sensitive information to prevent recovery of at least a portion of said sensitive information.

12. The system of claim 11 wherein said first security mode is a park security mode wherein said controller is configured to:
place the apparatus carrying the memory in the park security mode in response to a received park security mode selection; and
in response to said motion detector detecting motion of the apparatus carrying said nonvolatile memory while the controller is in the park security mode, change bits of said data of said sensitive information when said apparatus is detected to be in motion while in said park security mode.

13. The system of claim 12 wherein said controller is configured to enable said switch when said apparatus is placed in the park security mode, so that said generated current is directed to said controller so that so that bits of said data of said sensitive information are changed by said generated current when said apparatus is in motion while in said park mode.

14. The system of claim 13 wherein selector input is configured to input a second mode selection other than said park mode, wherein said controller is configured to disable said switch when said apparatus is placed in the second mode which disables said directing said generated current to said controller so that any current generated by motion of the coil through the earth's magnetic field when the apparatus is in the second mode is disabled from changing bits of said data of said sensitive information when said apparatus is in motion while in said second mode.

15. A method, comprising:
protecting sensitive information stored as data in at least a portion of a memory, said protecting including:
selectively placing an apparatus carrying the memory in a security mode;
detecting a first event while in the security mode; and
in response to said first event detecting, changing bits of said data of said sensitive information to prevent recovery of at least a portion of said sensitive information by reading said portion of said memory.

16. The method of claim 15 wherein said memory is a nonvolatile memory and wherein said detecting a first event includes detecting motion of the apparatus carrying said nonvolatile memory.

17. The method of claim 16 wherein the motion detecting includes generating a current in a coil by electromagnetic induction caused by motion of the coil through the earth's magnetic field.

18. The method of claim 17 wherein said changing bits of said data including directing said generated current to a controller, said controller using said generated current to change bits of said data of said sensitive information to prevent recovery of at least a portion of said sensitive information.

19. The method of claim 16 wherein the placing an apparatus carrying the memory in a security mode includes selectively placing the apparatus in a park security mode, wherein said detecting the first event includes detecting whether the apparatus is in the park security mode, and detecting motion of the apparatus carrying said nonvolatile memory when the apparatus is in the park security mode so that bits of said data of said sensitive information are changed when said apparatus is detected to be in motion while in said park mode.

20. The method of claim 18 further comprising selectively placing the apparatus in a park security mode which enables said directing said generated current to said controller so that motion of the coil through the earth's magnetic field when the apparatus is in the park mode, generates current which is directed to said controller so that bits of said data of said sensitive information are changed by said controller using current generated when said apparatus is in motion while in said park mode.

21. The method of claim 20 further comprising selectively placing the apparatus in a second mode other than said park mode, which disables said directing said generated current to said controller so that any current generated by motion of the coil through the earth's magnetic field when the apparatus is in the second mode is disabled from changing bits of said data of said sensitive information when said apparatus is in motion while in said second mode.
